(19) United States
(12) Patent Application Publication
(10) Pub. No.: US 2009/0064118 A1
(43) Pub. Date: Mar. 5, 2009

(54) SOFTWARE DEOBFUSCATION SYSTEM AND METHOD

(76) Inventor: Jason Neal Raber, Bellbrook, OH (US)

Correspondence Address: KELCE WILSON, 1205 TERRACE MILL DRIVE, MURPHY, TX, 75094, US

(21) Appl. No.: 12/193,033

(22) Filed: Aug. 17, 2008

Related U.S. Application Data
(60) Provisional application No. 60/968,569, filed on Aug. 29, 2007.

(51) Int. Cl. G06F 9/45

(52) U.S. Cl. 717/159

(57) ABSTRACT

A system and method are disclosed that enable automated deobfuscation of software. A method may include identifying at least one section of target software matching trigger criteria, either by using pattern matching or behavior analysis; emulating at least a portion of the identified section; and generating deobfuscated software by substituting a simplified section for the identified section. The method may further be iterated. Emulation includes simulating the effect of certain instructions on control flow and/or memory locations, such as the program stack, a register, cache memory, heap memory, or other memory. The simplified section may comprise a number of no operation (NOP) instructions replacing, which may then be jumped for further simplification.

### RELATED APPLICATIONS

This application claims priority from U.S. Provisional Application No. 60/968,569, entitled “SOFTWARE DEOBFUSCATION SYSTEM AND METHOD”, filed on Aug. 29, 2007, the disclosure of which is hereby incorporated in its entirety by reference.

### TECHNICAL FIELD

The invention relates generally to software optimization and more particularly, to simplification of executable software programs.

### BACKGROUND

Malicious software, such as viruses, worms, Trojan horse programs, spyware, and other malware, may use software obfuscation techniques to hide malicious behavior in order to make analysis and removal more difficult. Software obfuscation increases the amount of time it takes for identifying, understanding malware algorithms, which may delay the time before a fix becomes available. Software obfuscation used by malware may include unnecessary complications in instruction sequences, such a set of instructions that is effectively useless or includes an unnecessarily high number of steps, overly complex control flow, such as unnecessary jumps or opaque predicates, unnecessary use of the stack or registers, attempts to confuse debuggers regarding which bytes represent data or instructions, and other methods intended to confuse and delay a reverse engineer and/or reverse engineering tools. These techniques makes algorithms difficult to understand. Unfortunately, manual obfuscation removal is a tedious and error-prone process.

### SUMMARY

Identifying a section of target software, which matches trigger criteria, emulating the section to identify its functionality, and substituting a simpler set of data and/or instructions having equivalent functionality, allows for automated software deobfuscation. Deobfuscation may be recursive or iterated multiple times, with a first pass performing some simplification, and subsequent passes simplifying the already-simplified software even further.

Some embodiments of methods of deobfuscating software embodied on a computer readable medium comprise identifying at least one section of target software matching trigger criteria, emulating at least a portion of the identified section to determine a first function, and generating deobfuscated software by substituting a simplified section for the identified section, wherein the simplified section has a second function equivalent to the first function. A function may be a repeatable, measurable effect on computer memory. Some embodiments further comprise reading the target software from a computer readable medium and/or writing the deobfuscated software to a computer readable medium. The simplified section of software may contain one or more no operation (NOP) instructions, which creates slack space and, in some embodiments, the simplified section is the same length in bytes as the replaced identified section. Emulating the identified section of target software may comprise simulating the effect of the identified section on a memory location and/or control flow. The memory location may be a program stack, a register, a cache location, or general random access memory (RAM). Control flow may be analyzed by examining the effect of jump instructions on the execution pointer and other memory locations.

In some embodiments some or all of the target software, deobfuscated software, identified section and simplified section are represented with assembly language instructions. Identifying a section of the target software for emulation and/or simplification may involve pattern matching and/or behavior analysis of the software. A deobfuscator may use a predefined set of modes, wherein different modes use different rule sets for generating the deobfuscated software. Some modes may be more aggressive than other modes, and make more assumptions regarding the function of the software. Some embodiments insert jump instructions to bypass long sections of NOPs. An embodiment of a deobfuscation system comprises a specially-configured hardware device, such as a field programmable gate array (FPGA) or application specific integrated circuit (ASIC). A tangible, useful and concrete hardware device embodiment comprising a processor and memory takes in target software as a data stream input and generate deobfuscated software as a data stream output.

The foregoing has outlined the features and technical advantages of the invention in order that the description that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a software control flow graph of target software before deobfuscation;

FIG. 2 illustrates a software control flow graph of deobfuscated software generated from the target software of FIG. 1;

FIG. 3 illustrates a method of software deobfuscation; and

FIG. 4 illustrates a deobfuscation system.

### DETAILED DESCRIPTION

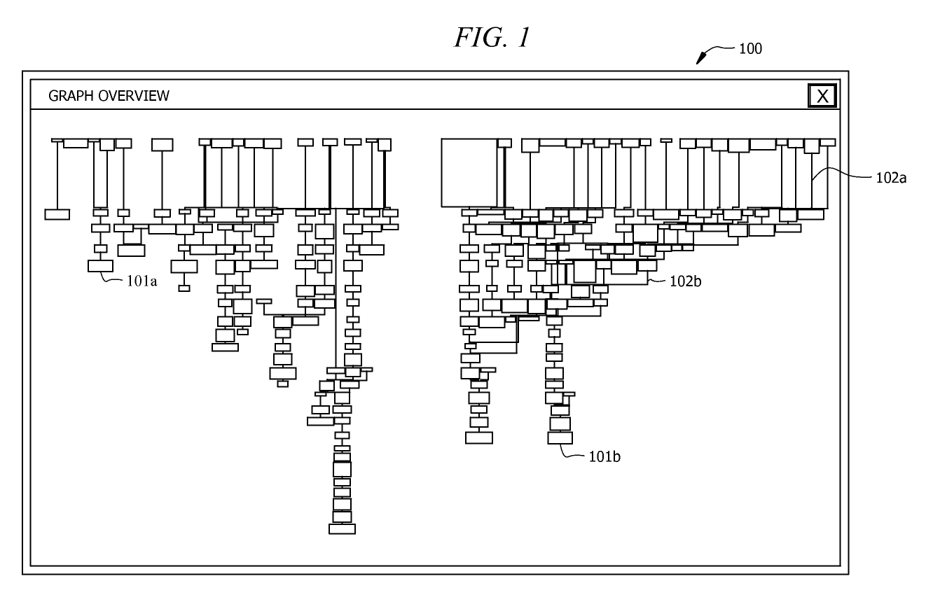

FIG. 1 illustrates a software control flow graph 100 of target software before deobfuscation. Control flow graph 100 comprises boxes 101a and 101b indicating software sections, each having a specific function that produces a repeatable, measurable effect on computer memory and also software control flow. Control flow indicators 102a and 102b indicate the control flow of the target software between the various software sections. Each of the boxes, for example boxes 101a and 101b, comprise representations of the software, typically in assembly language, although it should be understood that other representations, such as machine language, a high level language, such as C, or a graphical representation, such as a nested lower level control flow graph, may be also used. The target software may be configured to run on a personal computer (PC), cellular telephone or other communication device, a personal digital assistant (PDA), a game device, an audio device, a video device, or any other device capable of executing processor instructions. Control flow graph 100 represents the software control flow for a commonly-known malware program, and is intentionally complicated in order to slow down defensive efforts.

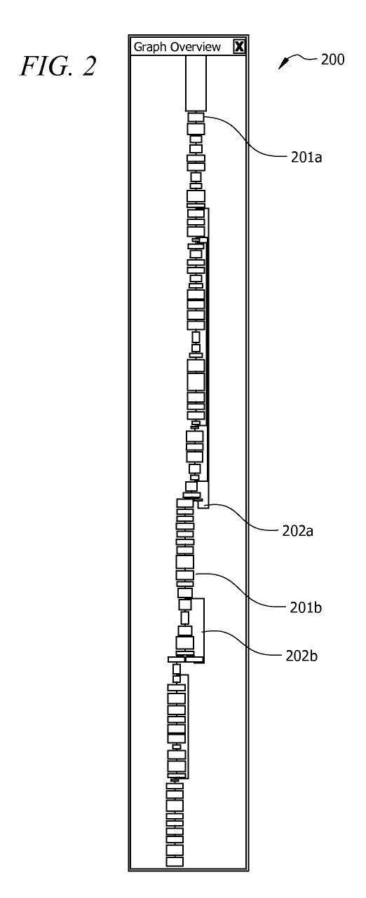

FIG. 2 illustrates a software control flow graph 200 of deobfuscated software generated from the target software of FIG. 1. Control flow graph 200 comprises boxes 201a and 201b indicating software sections, each having a specific function that produces a repeatable, measurable effect on computer memory and also software control flow. Control flow indicators 202a and 202b indicate the control flow of the deobfuscated software between the various software sections. Each of the boxes, for example boxes 201a and 201b, comprise representations of the software, typically in assembly language, although it should be understood that other representations, such as machine language, a high level language, such as C, or a graphical representation, such as a nested lower level control flow graph, may be also used. The deobfuscated should be able to run on the same device as the target software, and produce the same final result.

A comparison of FIG. 1 and FIG. 2 reveals that, while the target software represented in FIG. 1 has a confusing control flow, the control flow of the deobfuscated software in FIG. 2 is considerably easier for human understanding. Thus, the deobfuscation process renders reverse engineering of the target software considerably easier. This useful result can then be leveraged to improve malware defense, such as improving anti-virus and anti-spyware protections.

Some of the novel aspects of automated software deobfuscation, performed in accordance with an embodiment of the invention, are sections of the target software are subject to emulation. That is, rather than the software section being sent to execute on a central processing unit (CPU) or other processor, the effects of the software section on a virtualized processor and virtualized memory are determined. Based on the determined function, a simplified section of software, having the same function, may be substituted. In some embodiments, the substitute simplified section uses a same number of bytes as the replaced section. If the simplified section uses operable instructions requiring fewer bytes, the difference is made up with no operation (NOP) instructions.

For example, a section of the target software may be analyzed and determined to have no ultimate or lasting effect on any memory locations, such as a program stack, a register, or memory that has been allocated to the process. In such a situation, the replacement simplified section would comprise a set of NOPs that is as long as the replaced section of useless instructions. In some embodiments, a jump is inserted to skip a long string of NOP instructions. In some embodiments, a long string of NOP instructions may be deleted, and other jumps recalculated to ensure that the proper destination point is reached when jumping to instructions after the removed set of NOPs.

As another example, a set of multiple jump commands, wherein at least one is a conditional jump, may be analyzed and shown to result in the same net effect, whether a conditional jump is taken or not. One implementation of this type of obfuscation is for one jump to point to a first memory location that contains a NOP, and a second jump to point to a second memory following the first memory location. If the first jump is taken the result would be that a processor receives NOP instructions until the execution pointer points to the second memory location, making the jumps to different memory locations have no different effects. In this situation, any conditional tests leading to a conditional jump are unnecessary and may be replaced with NOPs, and all jumps may then be replaced with a single jump. As another example, values may be pushed onto the program stack and then removed, using PUSH and POP instructions, such that the net effect on the program stack memory is nulled out. The PUSH and POP instructions, along with the data, may then be replaced with NOPs. These NOPs create slack space, which may be used in the event that a simplified set of instructions actually requires more bytes of memory. As yet another example, PUSH and POP instructions may be replaced with a single MOV instruction, under certain conditions.

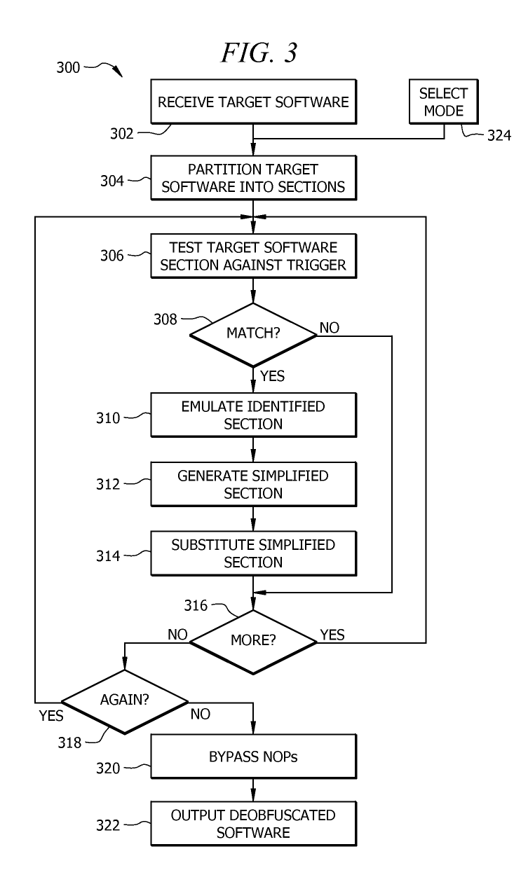

FIG. 3 illustrates a method 300 of software deobfuscation. It should be understood that method 300 is an embodiment of the invention, but other embodiments may also be used. In block 302, the target software is received, for example by reading the target software from a computer readable medium or by receiving a data stream input. In block 304, the target software is partitioned into sections. IDA Pro is one reverse engineering tool capable of partitioning software into sections and producing control flow graphs as shown in FIGS. 1 and 2. An embodiment of method 300 may work with IDA Pro, such as acting as a plug-in to IDA Pro and/or by using data structures common with IDA Pro. In block 306, a set of instructions in the target software is tested against trigger criteria. The set of instructions may be multiple instructions or a single instruction. In some embodiments, matching against the trigger criteria comprises pattern matching based on, for example, jump instructions, math operations including XORs and stack operations such as PUSH and POP and also MOV instructions. In some embodiments matching against the trigger criteria comprises behavior analysis of the software.

In decision block 308, if a match is determined between the tested instruction set in the target software and trigger criteria, the instruction set is identified as obfuscated software. If, in decision block 308, a match is not detected, method 300 moves to decision block 316 to determine whether another section of the target software needs to be tested against the trigger criteria.

Obfuscation can take many forms, including the incorporation of useless and confusing instructions, mangled jumps, unnecessary data cross-references, and other techniques, such as anti-disassembly techniques that are designed to prevent the generation of an assembly language representation of the software. For example the identified section may PUSH a value onto the stack, POP it into a register, such as EAX, perform a math operation on the contents of EAX, such as an XOR, and then JMP to the contents of EAX. The function of this identified section is merely to jump to a calculated address, and could be replaced with a simply JMP instruction with the same calculated value, followed by NOPs to replace the excess number of bytes used by the original set of instructions.

Another identified section could include a series of NOPs with a JZ and a JMP instruction to various locations within the string of NOPs. No matter which jump is followed, the end result is effectively the same. Thus, the JZ and JMP are useless instructions. Some obfuscation will include alternate conditional jumps, JZ and JNZ, to the same location, making the condition check useless. Such an identified section has a function of jumping to a certain location, no matter what the value was used in the condition check. If a register is used for math operations, and the result is not used in a meaningful manner, the math instructions may be useless and are candidates for replacement with NOPs. It should be understood, though, that deobfuscation may require multiple iterations, if for example, one pass through the target software creates simplifications that enables further simplification during a subsequent pass.

Some examples of anti-disassembly include jumping into the middle of an instruction or a data value, which then alters which bytes are identified by a disassembler as instructions versus which bytes are interpreted as data. Such a change could drastically alter a control flow graph, and allow progress in understanding the algorithm.

In block 310, the identified section, as determined in decision block 308, is emulated to determine its function, for example to identify its effect on a memory location and/or control flow. The emulation tracks register math to determine the end result of calculations, so that, in some situations, the end result may be used in place of the instructions used to calculate it. The emulation also determines jump locations and function calls, and tracks register and stack operations. In block 312, simplified code is generated having the same function as determined during emulation. The simplified code has the same number of bytes as the identified section, using NOPs to create slack space when the simplified section uses fewer bytes for instructions. The slack space may be used in subsequent iterations of the deobfuscation, in the event that additional bytes are needed to substitute a simplified instruction. In block 314, the simplified section is injected over the identified section with a binary injector. In some embodiments, the binary injector may comprise a PERL script.

In decision block 316, method 300 determines whether more sections of the software require testing for deobfuscation. If so, method 300 returns to block 306. Otherwise, method 300 proceeds to decision block 318 to determine whether the deobfuscation process needs to be iterated again from block 304. Stopping criteria may be automated, for example by using a threshold for the number of substitutions during the previous pass, or it may be determined manually by user interaction. Method 300 may use IDA Pro for interfacing with a user and the target software, and thus present the user with a control graph and disassembly results so that the user can determine whether another iteration of deobfuscation is desired. At block 320, the slack space is bypassed by inserting jump instructions to skip long sections of NOPs.

The deobfuscation process of method 300 is controlled by a rule set, and the settings are selected in block 324. In one embodiment, the rule set has five mode settings: (1) Anti-disassembly—replace anti-disassembly with simplified code; (2) Passive—use safe assumptions about memory content changes and usage; (3) Aggressive—use more aggressive assumptions about memory content changes and usage; (4) Ultra—uses even more aggressive assumptions about memory content changes and usage; (5) Remove NOPs—optionally remove slack space. In block 322, the deobfuscated software is output, for example by writing the target software to a computer readable medium or by producing an output data stream.

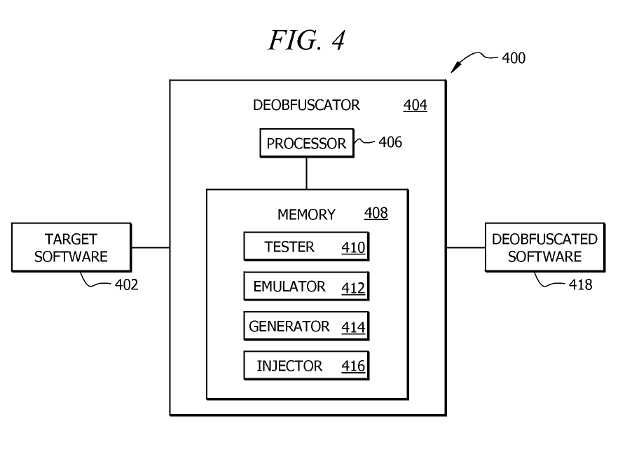

FIG. 4 illustrates a deobfuscation system 400, comprising target software 402, deobfuscator 404 and deobfuscated software 418. Deobfuscator 404 and takes target software 402 as an input and outputs deobfuscated software 418. In the illustrated embodiment, deobfuscator 404 comprises a processor 406 and a memory 408. Memory 408 comprises a tester 410, an emulator 412, a generator 414 and an injector 416. Memory 408 may comprise volatile memory, non-volatile memory, magnetic media, optical media, or other computer-readable media. Tester 410 determines whether a section of target software 402 matches trigger criteria. Emulator 412 determines the functions of identified sections of obfuscated software. Generator 414 generates simplified software, and injector 416 injects the simplified software to create deobfuscated software 418. In some embodiments, deobfuscator 404 comprises a specially-configured hardware device, such as a field programmable gate array (FPGA) or application specific integrated circuit (ASIC). Target software 402 and deobfuscated software 418 may also reside in memory 408, or other memory and/or computer readable media coupled to processor 406.

Although the present invention and its advantages have been described, it should be understood that various changes, substitutions and alterations can be made herein without departing from the spirit and scope of the invention as defined by the appended claims. Moreover, the scope of the present application is not intended to be limited to the particular embodiments of the process, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of deobfuscating software embodied on a computer readable medium, the method comprising:
identifying at least one section of target software matching trigger criteria;
emulating at least a portion of the identified section to determine a first function; and
generating deobfuscated software by substituting a simplified section for the identified section, the simplified section having a second function equivalent to the first function.

2. The method of claim 1 further comprising:
reading the target software from a computer readable medium.

3. The method of claim 1 further comprising:
writing the deobfuscated software to a computer readable medium.

4. The method of claim 1 wherein substituting a simplified section comprises substituting a simplified section comprising at least one no operation (NOP) instruction, and wherein the simplified section uses a same number of bytes as the identified section.

5. The method of claim 1 wherein emulating at least a portion of the identified section comprises simulating an effect of the identified section on at least one selected from the list comprising:
a memory location and control flow.

6. The method of claim 1 further comprising representing the simplified section with assembly language instructions.

7. The method of claim 1 wherein identifying at least one section comprises matching a pattern of instructions.

8. The method of claim 1 wherein identifying at least one section comprises analyzing behavior.

9. The method of claim 1 further comprising:
selecting an emulation mode from a predefined set of emulation modes, wherein different ones of the set of emulation modes use different rule sets for generating deobfuscated software.

10. The method of claim 1 further comprising:
inserting jump instructions to bypass sections of no operation (NOP) instructions.

11. A computer program embodied on a computer readable medium, the program comprising:
code for identifying at least one section of target software matching trigger criteria;
code for emulating at least a portion of the identified section to determine a first function; and
code for generating deobfuscated software by substituting a simplified section for the identified section, the simplified section having a second function that is equivalent to the first function.

12. The program of claim 11 further comprising:
code for reading the target software from a computer readable medium; and
code for writing the deobfuscated software to a computer readable medium.

13. The program of claim 11 wherein the code for generating deobfuscated software comprises code for substituting a simplified section comprising at least one no operation (NOP) instruction, wherein the simplified section uses a same number of bytes as the identified section.

14. The program of claim 11 wherein the code for emulating at least a portion of the identified section comprises code for simulating an effect of the identified section on at least one selected from the list comprising:
a memory location and control flow.

15. The program of claim 11 further comprising code for representing the simplified section with assembly language instructions.

16. The program of claim 11 wherein the code for identifying at least one section of target software comprises code for pattern matching.

17. The program of claim 11 wherein the code for identifying at least one section of target software comprises code for behavior analysis.

18. The program of claim 11 further comprising:
code for selecting an emulation mode from a predefined set of emulation modes, wherein different ones of the set of emulation modes use different rule sets for generating deobfuscated software.

19. The method of claim 11 further comprising:
code for inserting jump instructions to bypass sections of no operation (NOP) instructions.

20. A deobfuscation system comprising:
at least one processor; and
memory coupled to the at least one processor, wherein the memory and the at least one processor are configured to:
receive target software;
identify at least one section of the target software matching trigger criteria;
emulate at least a portion of the identified section to determine a first effect of the identified section on a memory location and control flow;
generate deobfuscated software by substituting a simplified section for the identified section, wherein the simplified section has a second effect on the memory location and the control flow that is equivalent to the first effect; and
output the deobfuscated software.
